(19) United States
(12) Patent Application Publication
(10) Pub. No.: US 2005/0045421 A1
(43) Pub. Date: Mar. 3, 2005

(54) Ladder securement device

(76) Inventor: Robert G. Gaines, Brighton, MI (US)

Correspondence Address: CARGILL & ASSOCIATES, P.L.L.C., 56 MACOMB PLACE, MT. CLEMENS, MI, 48043, US

(21) Appl. No.: 10/903,690

(22) Filed: Jul. 30, 2004

Related U.S. Application Data
(60) Provisional application No. 60/491,178, filed on Jul. 30, 2003.

(51) Int. Cl. E06C 7/42

(52) U.S. Cl. 182/107

(57) ABSTRACT

A ladder securement device for attachment to a building and for helping to secure a ladder leaning up against that building. Included is a roof attachment for attaching to a roof edge of a building and a securement device permanently fastened to the roof attachment. The securement device is adapted to receive a ladder so that it is less likely that a ladder leaning against the building will come away from the building, thereby creating an unsafe situation of the ladder. At least one ladder catcher is permanently affixed to the securement device for receiving at least a portion of the ladder. The securement device may include at least one end plate for helping to prevent a ladder leaning against the building from shifting side to side, as well as at least one ladder rung catcher for helping to prevent a ladder leaning thereagainst from coming away from the building. In addition, the ladder securement device may include both end plates and ladder rung catchers for helping to prevent a ladder leaning thereagainst from both sliding down in a side to side motion, or from coming away from the building.

### CROSS REFERENCES TO RELATED APPLICATIONS

This application claims the benefit of U.S. Provisional Application Ser. No. 60/491,178 filed on Jul. 30, 2003.

### BACKGROUND OF THE INVENTION

1. Field of the Invention

The present invention relates to attachments to buildings. More particularly, the invention relates to a ladder securement device for attaching to a building.

2. Description of the Prior Art

As long as ladders have been used against buildings, they have caused problems with falling over or tipping to one side. In addition, accidents have occurred when the base slips away from a building. In the large commercial buildings that are constantly in need of maintenance, there is always a need for a maintenance man to rest a ladder on the side of the building in order to get up onto the roof. In order to have access to heating, ventilation and air conditioning units these maintenance crews need to be on the roof. Putting ladders up onto commercial buildings, which may be as tall as two or three stories high, is a very dangerous operation. On taller buildings, there are safety code requirements for permanently attached ladders to prevent the falling over of the maintenance men when they are standing on their ladders. However, for buildings that are one, two or even three stories tall, maintenance men are left to their own devices for safety.

The inventor realized this problem, and its respective safety issues. He saw the advantages of putting a ladder securement device at the top of a building. This would be either a permanent or a temporary fixture, so that anytime a maintenance crew needed to scale a ladder to come to the roof of a building, they would be able to do so with increased safety, and with less fear of falling.

Therefore, it is an aspect of the present invention to provide a ladder securement device for receiving a ladder, which is preferably permanently attached to the building. Maintenance men can lean their ladders against the ladder securement device, knowing that it will be more difficult for that ladder to slide from side to side or tip backwards, causing a fall. Furthermore, ladders may be more secure on slippery surfaces where the bottom base can slip out from under them.

It would be of a great advantage to the maintenance industry if there was provided a ladder securement device to alleviate some of the fear of using a ladder leaned up against a building.

### SUMMARY OF THE INVENTION

In accordance with the above-noted advantages and desires of the industry, the present invention provides a ladder securement device for attachment to a building and for helping to secure a ladder leaning up against that building. Included is a roof attachment for attaching to a roof edge of a building and a securement device permanently fastened to the roof attachment. The securement device is adapted to receive a ladder so that it is less likely that a ladder leaning against the building will come away from the building, thereby creating an unsafe situation of the ladder. At least one ladder catcher is permanently affixed to the securement device for receiving at least a portion of the ladder. The roof attachment includes a roof attachment selected from the group consisting of metal plates, formed metal wire, formed plastic handles, cutout metal plates, and combinations thereof. Furthermore, the securement device may include at least one end plate for helping to prevent a ladder leaning against the building from shifting side to side.

Preferably, the ladder securement device may include at least one ladder rung catcher for helping to prevent a ladder leaning thereagainst from coming away from the building. In addition, the ladder securement device may include both end plates and ladder rung catchers for helping to prevent a ladder leaning thereagainst from both sliding down in a side to side motion, or from coming away from the building.

Although not exhaustive for various roof edge configurations, many embodiments are included to illustrate the concepts and advantages of the present invention. Although the invention will be described by way of examples hereinbelow for specific embodiments having certain features, it must also be realized that minor modifications that do not require undo experimentation on the part of the practitioner are covered within the scope and breadth of this invention. Additional advantages and other novel features of the present invention will be set forth in the description that follows and in particular will be apparent to those skilled in the art upon examination or may be learned within the practice of the invention. Therefore, the invention is capable of many other different embodiments and its details are capable of modifications of various aspects which will be obvious to those of ordinary skill in the art all without departing from the spirit of the present invention. Accordingly, the rest of the description will be regarded as illustrative rather than restrictive.

### BRIEF DESCRIPTION OF THE DRAWINGS

For a further understanding of the nature and advantages of the expected scope and various embodiments of the present invention, reference shall be made to the following detailed description, and when taken in conjunction with the accompanying drawings, in which like parts are given the same reference numerals, and wherein:

FIG. 1 is a perspective view of a ladder securement device for a flat roof application made in accordance with the present invention;

FIG. 2 illustrates another embodiment of the flat roof ladder securement device, including another feature of a ladder rung catcher;

FIG. 3. is a perspective view of a ladder in place on another embodiment of one of the ladder securement devices of the present invention;

FIG. 4 is a perspective view of another aspect of the present invention utilizing bent wire;

FIG. 5 is a perspective view of a combination wire and solid plate embodiment;

FIG. 6 is a perspective view of another aspect of the present invention including an adjustable angle ladder securement device made in accordance with that aspect;

FIG. 7 is a perspective view of another aspect of the present invention illustrating a flat roof adaptation of another aspect;

FIG. 8 is a perspective view of another aspect of the present invention illustrating a simplified embodiment;

FIG. 9 is a perspective view of another aspect of the present invention for a flat roof adaptation for a gutter of another embodiment;

FIG. 10 is a perspective view of another aspect of the present invention, made to provide clearance for wall attachments;

FIG. 11 is a perspective view of another aspect of the present invention showing an adjustable wall mount leg;

FIG. 12 is a side elevational view of another aspect of the present invention that incorporates a clearance for a roof curb;

FIG. 13 is a perspective view of another aspect of the present invention where a raised portion of the top plate accommodates a stone stop edge roof;

FIG. 14 is a perspective view of another aspect of the present invention for residential roofing applications; and

FIG. 15 is a perspective view of yet one more another aspect of the present invention, showing an adjustable wall mount.

### DETAILED DESCRIPTION OF THE INVENTION

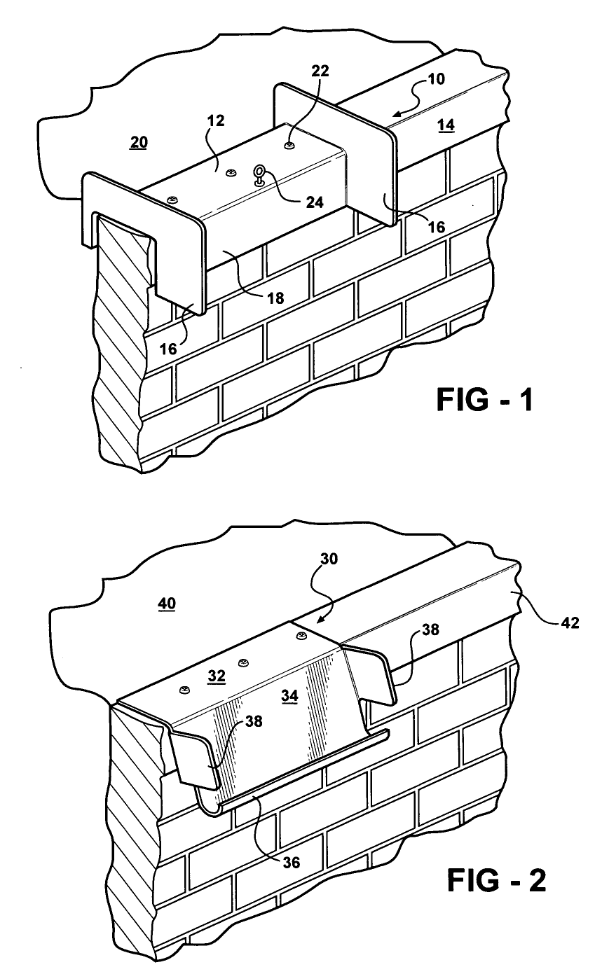

In accordance with the desires and advantages of the present invention, as described above, the present invention discloses a ladder securement device as shown in FIG. 1, and generally denoted numeral 10. Ladder securement device 10 may generally include a roof cap 12 to be received over the top edge of a building such as over a building parapet 14. Generally, building parapets are of conventional sizes and shapes, so a modest number of sizes of the roof cap 12 can be made to accommodate the various building parapet 14 dimensions. Roof cap 12 is secured to the top of building parapet 14 by ladder securement device fasteners 22. These fasteners may include any suitable conventional fasteners. At either side of the ladder securement device 10, are ladder catchers 16, also attached to ladder securement device faceplate 18. An optional welded on ladder tie 24 may be utilized somewhere in or near the center of the ladder securement device 10 in order to give yet further assurances to the maintenance crewman who has placed the ladder thereon. The ladder will not be as likely to tip over backwards. Therefore, in addition to the side-to-side motion being deterred by ladder catchers 16, the ladder may also be tied in place against ladder securement device faceplate 18 after it has been tied down to ladder tie 24. In operation, the crewman would place his extension ladder up between the ladder catchers 16 against the edge of the roof cap 12 and ladder securement device faceplate 18. He may then use a tie down to further secure his ladder to the welded on ladder tie 24. As the crewman walks up the ladder, he can approach the building roof 20 knowing that his ladder will not tip from side-to-side nor will it fall backward. Consequently, he can carry pieces of equipment up the ladder with a greater degree of surety and safety, and the ladder securement device can be permanently mounted to the building so that it will be there anytime the maintenance crewman needs to put a ladder against the side of the building to get up to the building roof 20.

Roof cap 12 may have a slight angle to it so that it will not hold rain and cause fungus or mildew thereon. It may also be fashioned of a plastic material having a high density, such as HDPE, EPDM, or other plastics, which may resist birds and the like. Furthermore, although FIG. 1 shows the basic form of the present invention, it is also envisioned that the ladder securement device may be formed out of bent rods so as to minimize the amount of material utilized, and also to protect against the use of materials which are attractive to birds and insects. Further embodiments hereinbelow will address such issues.

Looking next to FIG. 2, there is yet another embodiment of the present invention in which a ladder securement device is generally denoted by numeral 30, and includes a roof cap 32 which is fastened down permanently or semi-permanently to the building parapet 42. Alternatively, the ladder securement device may clip onto a building parapet so that it can be moved. The present embodiment may be made of stamped sheet metal, and bent on a brake in order to put an angle between roof cap 32 and ladder securement device faceplate 34, as shown in FIG. 2. There may be an optional ladder rung catcher 36 which may help to secure the ladder to the side of the building. Ladder catcher 36 may have a cut out area to engage a rung of the ladder. On either side, there would preferably be ladder catchers 38 to receive the ladder therebetween. The maintenance crew would put their ladder up onto the edge of roof cap 32 between ladder catchers 38. It is also envisioned by the present inventor that the rung catcher may be the only feature of any of these embodiments, i.e. without ladder catchers 38 on either side.

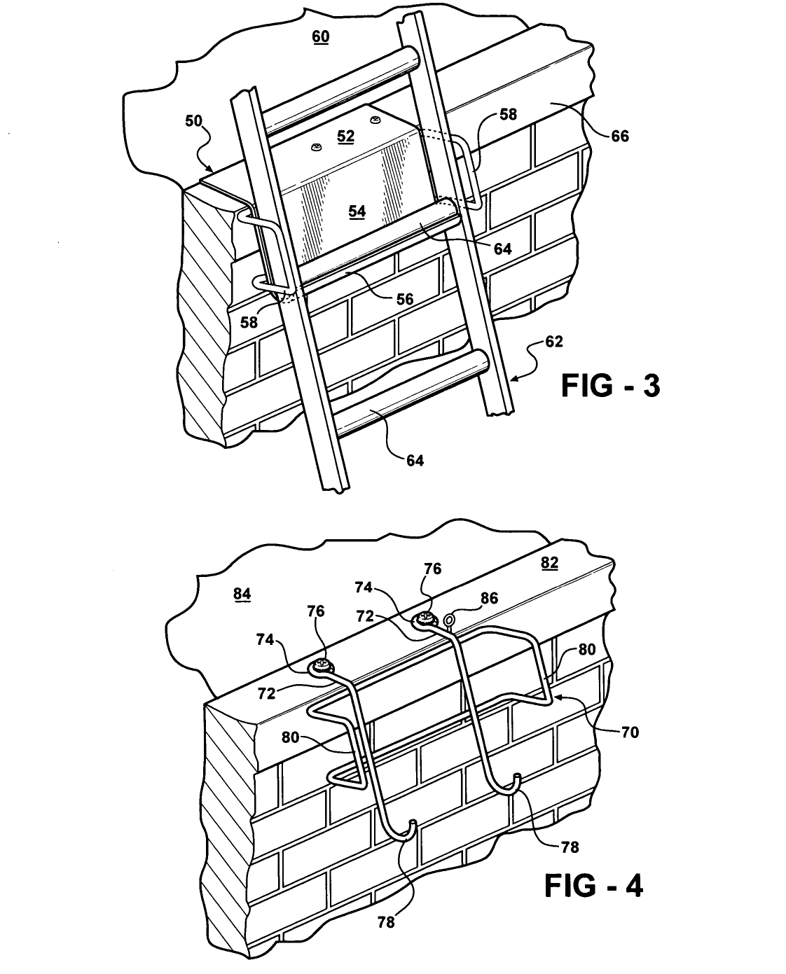

FIG. 3 shows yet another embodiment of the present invention in which the ladder securement device is generally denoted by numeral 50, and preferably includes a roof cap 52 and a ladder securement device faceplate 54. Rung catcher 56 is attached at the bottom of the ladder securement device, with or without cut out for foot access, and may include handrails 58 on either side, which act to give the workman a place to hold onto when climbing back down the ladder, and it also will act as a securement device to prevent a ladder from sliding side-to-side. Ladder 62 is shown with its ladder rung 64 being held within rung catcher 56. This entire device is held onto building parapet 66 while the workman climbs up the ladder to get onto building roof 60.

FIG. 4 illustrates yet another embodiment of the present invention, which is similar in operation to the embodiment of FIG. 3, however it is merely made out of bent rods, and preferably made of bent metal rods, and can include a permanent exterior finish, such as powder coated metal bent rods. This embodiment of the present invention is shown with ladder securement device generally denoted by the numeral 70, and including fastening arms 72 with fastener receiver loops 74 attached thereto in order to receive fasteners 76 for securing ladder securement device 70 to building parapet 82. In other embodiments, the looped fastener receivers 74 may extend further up and over the edge of building parapet 82, or any other secure configuration which is desired for specific applications. Extending downwardly from the edge of the parapet fastening arms 72 may be rung catchers 78 with a stabilizing bar extending therebetween, and being fastened to the face of the building parapet, preferably, for safety sake. Ladder catchers 80 function double time as handrails for the ladder climber, as well as for catching the ladder to prevent it from moving from side-to-side. Optional ladder tie down hooks 86 may also be incorporated for the ladder climber to tie his ladder to the tie down hook 86 in order to prevent the ladder from falling backward. In operation, the embodiment of FIG. 4 would function essentially the same as the embodiment of FIG. 3, wherein the ladder would be placed up against the edge of the building parapet 82 and the rung of the ladder closest to the top of the building parapet would be hooked within rung catchers 78.

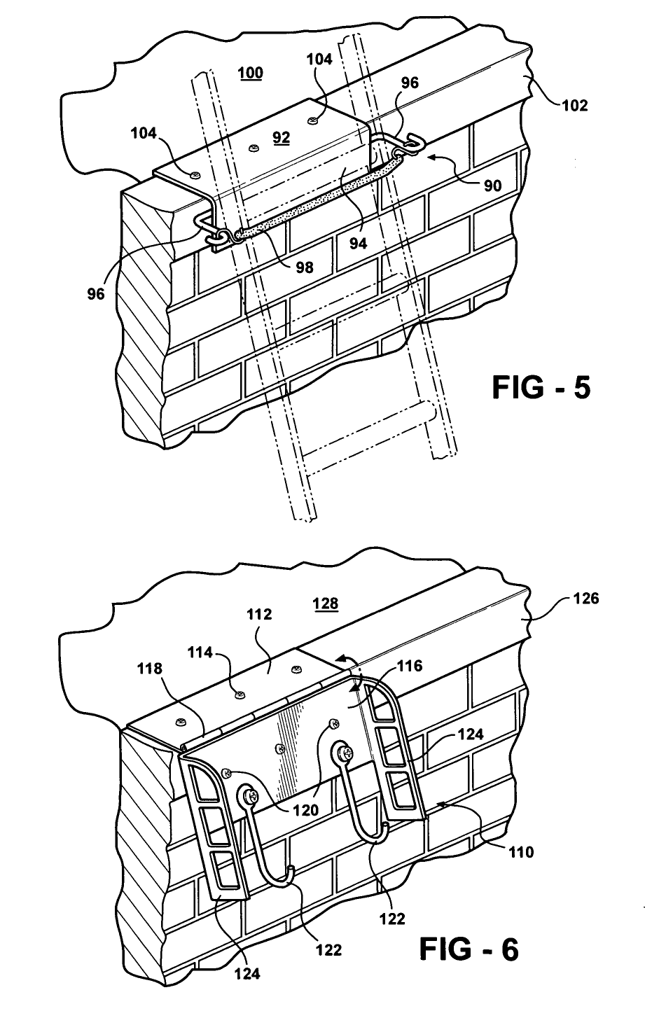

FIG. 5 is still yet another embodiment of the ladder securement device of the present invention, wherein the embodiment of FIG. 5 is a ladder securement device generally denoted by numeral 90, and includes a roof cap 92 as well as a ladder securement device faceplate 94 (shown in phantom). In this embodiment, it is the simplest device, as the roof cap 92 and faceplate 94 are part of a single piece of sheet metal which has been put on a brake and folded at the edge in order to be received over building parapet 102. Roof cap 92 may be secured to roof parapet 102 via fasteners 104. Fastened, by means such as welding, or the like, may be a bent rod ladder catcher 96 which shall be secure enough to hold the ladder from sliding side-to-side. Bent rod ladder catch 96 preferably includes hooks at the distal ends of the bent rod in order to receive a securement device for tying down the ladder once it is in place. Preferably, a bungee cord or other suitable securing device 98 may be utilized to secure the ladder to the bent rod ladder catcher 96, but may be also be a permanent hard rod which has been manufactured for this exact purpose. In addition, individual hooks and loops (not shown) may be utilized in place of the bungee cord 98, such that they are constantly attached to the rounded hook ends at either end of the bent rod ladder catcher 96. That way, when the ladder climber gets up to that point, he can release the chain or other loop material at either of the hook ends, and secure the sides of his ladder. It is envisioned that a hook-on-chain, similar to a dog collar, (not shown) could be utilized in short lengths such that the hook could be undone once the ladder was in position, and swung around the side of the ladder and rehooked around into the hook on the end of the bent rod ladder catcher for securing the ladder.

Looking next to FIG. 6, there is shown yet one more embodiment of the present invention, although there are many more that may be within the scope of this invention that may be utilized without undone experimentation on the part of one of ordinary skill in the art. This embodiment illustrates a ladder securement device, generally denoted by numeral 110, and includes a roof cap 112, with holes to receive fasteners 114 into building parapet 126 to secure the ladder securement device to the roof 128. Ladder securement device faceplate 116 may be hingably mounted to a roof cap 112 by a hinge 118, such as a piano hinge. Fasteners 120 may extend through faceplate 116 to secure the ladder securement device to the face of the building parapet 126. Rung catcher hooks 122 extend from the bottom of faceplate 116, in order to hold the ladder in an upright position. Ladder catchers with integral handrails 124 are shown at either end of the faceplate 116. Ladder catchers 124 may extend downwardly, as shown in FIG. 6, however it is also envisioned that they may extend upward and over the parapet to give yet more reassurance to the ladder climber, and give him a hand hold when he is climbing down the ladder. The face plate may be spring loaded to swing away from the building to meet the ladder and to assure engagement of hook 122 to the ladder rung. When not using fasteners 120, the spring loaded concept may be especially useful.

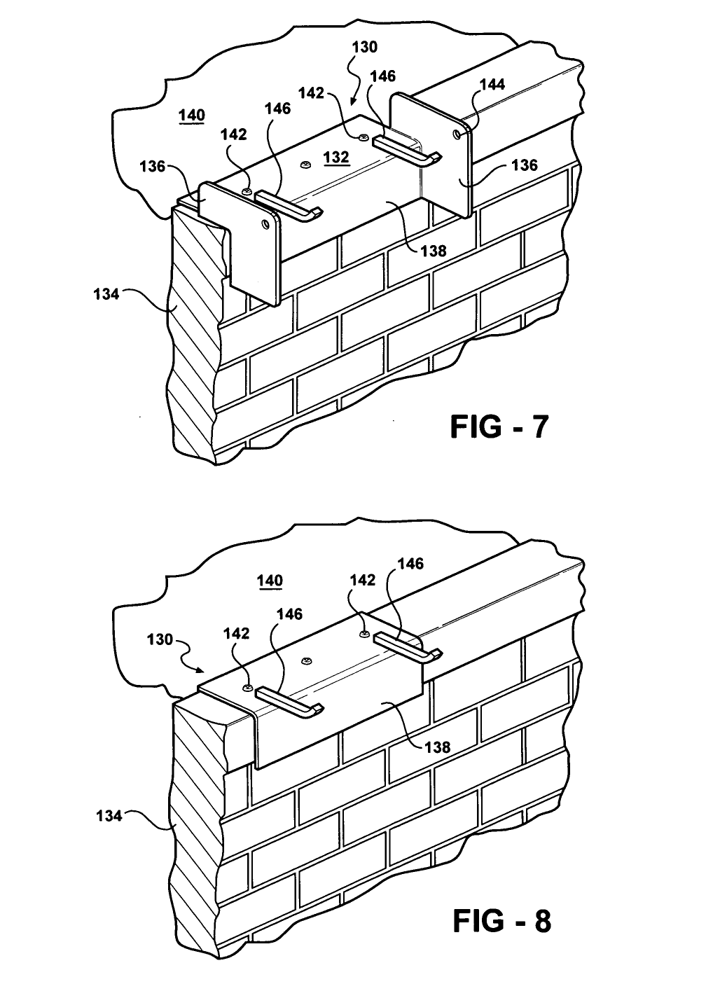

FIG. 7 illustrates still one more embodiment of the present invention, which is also similar in operation to the embodiments described hereinabove, although it contains certain aspects from some of the other embodiments. The ladder securement device as shown in FIG. 7 is generally denoted by the numeral 130. Ladder securement device 130 may include a roof cap 132 to be received over the top edge of a building 134. This ladder securement device may be secured to building 134 by securement device fasteners 142. On either side of ladder securement device 130 are ladder catchers 136 which may be welded or otherwise attached onto the roof cap 132, or they may be braked from a single piece of sheet metal integral with the roof cap 132. An optional ladder securement device face plate 138 lies across the front of building 134 and acts to further stabilize 10 securement device 130 onto the building. Ladder catching hooks 146 may be disposed at either end of the roof cap 132, in order to provide a catch for a rung on the ladder. Although two ladder rung catchers are shown in the present embodiment, it is envisioned by the inventor that more or less ladder rung catches 146 may be utilized. In practice, a worker would raise his ladder up to the edge of the building and hook one of the top rungs of his ladder onto ladder rung catchers 146, which would help to hold the ladder in place between the ladder catchers 136. As the ladder securement device 130 will be firmly and securely attached to building 134 by fasteners 142, the ladder should be secure. For some people, strap holes 144 are also provided to allow for the securement of a ladder with a strap that may hook through the strap holes 144 to add further confidence to the user. Although it is intended to be permanently mounted onto a building, ladder securement device 130 may also be a temporary attachment in order for the user to take the ladder securement device with him to other job sites.

The embodiment shown in FIG. 7 is preferably made of a stamped metal, such as aluminum or misch, galvanized aluminum or steel, or any suitable exterior grade metal finish. Of course, the ladder securement device may be powder coated or lacquered or painted in order to preserve it against the outside elements. Furthermore, the entire ladder securement device may be formed of a high density polyurethane plastic, or some other suitable plastic or polymeric material. In its most basic form, the ladder securement device of the present invention could be made of wood, composites, or any other suitable material.

It is further envisioned by the inventor that the ladder catchers 136 may not be necessary in this embodiment, but rather merely the roof cap 132 and the ladder rung catchers 146, as is shown in FIG. 8 with similar numerals to identical elements as shown in FIG. 7. The ladder securement device 130 of FIG. 8 is the same embodiment as that shown in FIG. 7 but without the side ladder catches 136. If ladder rung catchers 146 are placed appropriately with a distance apart of from about 6 inches to 2 feet, they will also act to prevent the ladder from slipping from side to side, as well as for the entire ladder tipping over backward. It is also envisioned by the inventor that only one-half of the shown ladder securement device may be made and installed onto buildings.

FIG. 9 illustrates yet one more embodiment of the present invention, in which the embodiments of FIGS. 7 and 8 have an added feature which goes to cover gutters. The ladder securement device generally denoted by numeral 130 includes an elongated roof cap 132 which extends from the side of building 134 and attaches onto roof 140, while extending outwardly from building 134 to more than cover gutter 150. Again, ladder catchers 136 may or may not be included on the side of roof cap 132 and ladder securement device face plate 138 extends downwardly and has an additional gutter cover 152 extending downwardly, preferably braked metal sheeting, ending in a gutter cover flange 154 for securement to the side of building 134. Again, fasteners 142 are used to secure the roof cap 132 onto roof 140. Strap holes 144 are optional, and have been discussed hereinabove with reference to the other figures. Likewise, ladder rung catchers 146 are in place in order to catch the ladder rung when it is put up against the building. Needless to say, the gutter cover 152 with its gutter cover flange 154 may be made of any length in order to accommodate a particular gutter 150 for any building 134. There are other modifications and variations to this embodiment, but such device 130 may be configured in such a way to accommodate anything that may be found on the side of a building, other than the gutter. For example, there may be electrical conduit boxes, or other utility features (none of these are shown) which may need to be covered by the ladder securement device 130. Depending on the size and shape of these other additional attachments to a building, the gutter cover 152 may need to be shorter or longer than that shown in the present figure. Consequently, the present invention may be modified, without undue experimentation, to accommodate anything that appears and extends outwardly from the side of the building. Furthermore, for safety reasons, a particular distance may be required to hang from the side of the building, and the present invention envisions all of those dimensions and will not allow for obvious modifications by someone who is trying to reproduce this invention.

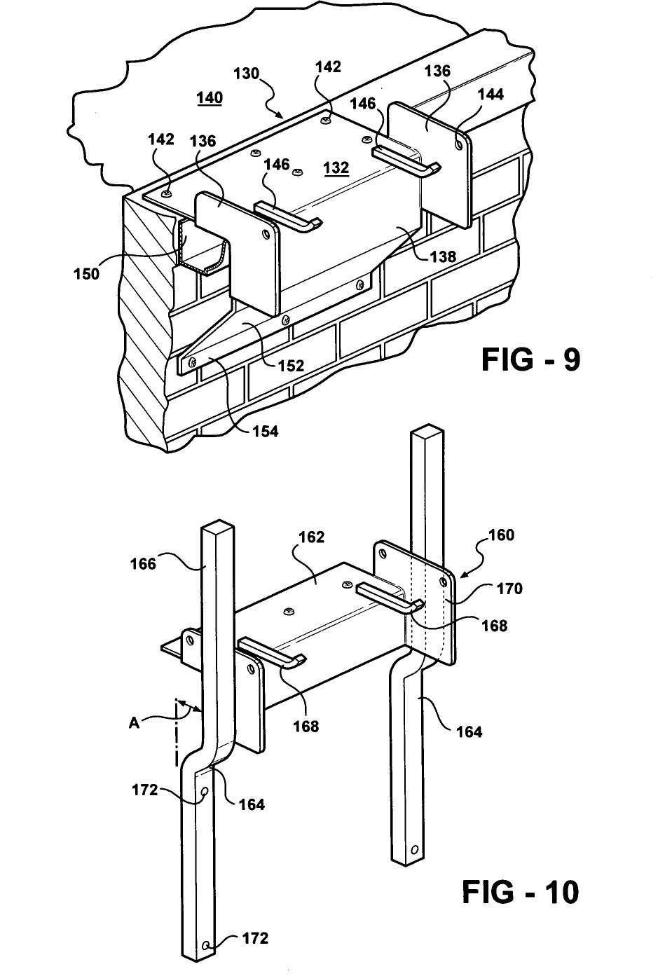

FIG. 10 illustrates yet one more embodiment of the present invention, in which a wall mount design is illustrated. In certain instances, a wall mount may be more advantageous for a particular application than a roof mounted ladder securement device. Looking to FIG. 10, the wall mount is generally denoted by numeral 160, and includes a base plate 162 extending between two frame members 164. Frame members 164 may have an extended region 166 which essentially forms a handle 166. The ladder rung catchers 168 are secured to base plate 162, and extend outwardly from the building in order to catch the rung of a ladder for a vertical drop. The frame members 164 may be fastened to the side of the building via fasteners 172. The ladder will be secured from side to side movement by end plates 170, which can be either constructed of a solid piece of sheet metal or plastic or any other suitable material, or it may preferably be made of wire or mesh or any other sturdy support material which will prevent the ladder from sliding from side to side. The ladder rung catchers 168 act to prevent the ladder from going up and down, while the end plates 170 act to prevent the ladder from going side to side.

In this embodiment, there may preferably be utilized a shift in dimension in the frame member 164 in order to avoid things on the wall, including curbs, gutters, window frames, or the like. The dimension “A” is used to illustrate that the frame member 164 may not be substantially vertical, but rather may be bent to accommodate other things attached to the wall. In addition, base plate 162 may be configured or modified or extended to allow additional attachment to buildings, or attachments to the building. Dimension “A” may be increased or decreased to allow clearance for gutters and other attachments to the building. It is also envisioned by the present inventor that spacers could be used between the frame member legs and the wall of the building to allow for clearance for miscellaneous protrusions, especially near the roof edge. The base plate 162 may also be used to catch the top of the roof if that configuration is desired.

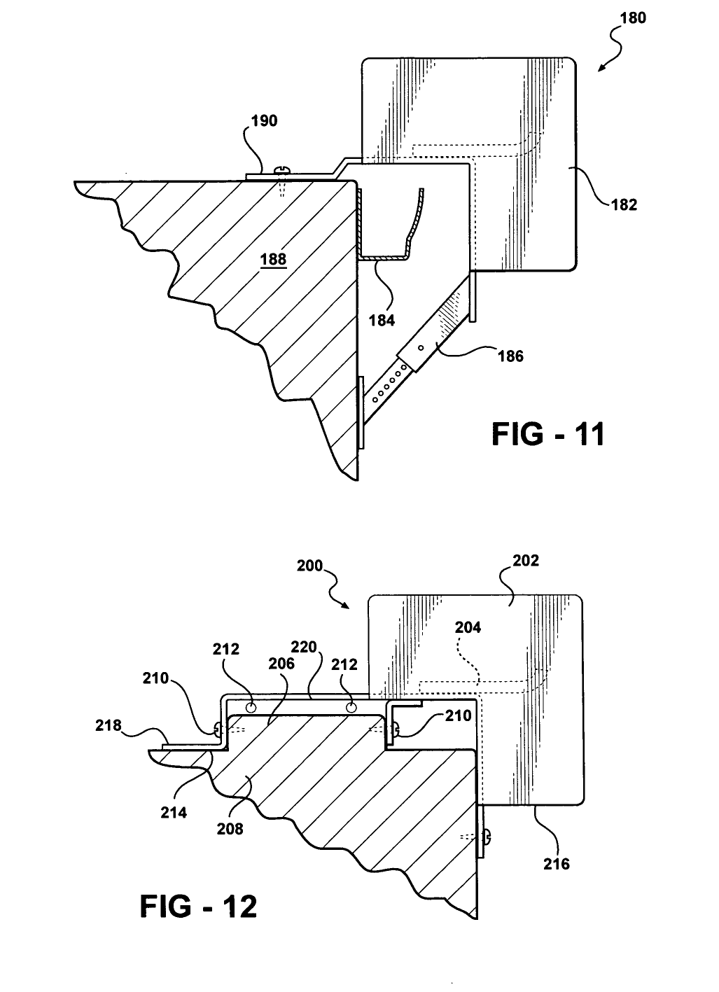

Looking next to FIG. 11, a gutter model ladder securement device is generally denoted by the numeral 180, and illustrates the placement of end plate 182 above and around a gutter 184. The gutter is generally attached to the building 188 near the roof edge. In order to allow clearance for the gutter, the present invention may utilize a telescoping wall mounting bracket 186 in order to make the ladder securement device 180 to be adjustable for many different applications and sizes of gutters. This element is a side elevational view of the embodiment of FIG. 11, and may also include a top securement plate 190 for securing to the top of building 188 via the roof. The telescoping mounting bracket can be eased in and out to accommodate any size of gutter. Again, this embodiment may be made using materials described hereinabove with reference to other embodiments, and may be modified in any of those ways described.

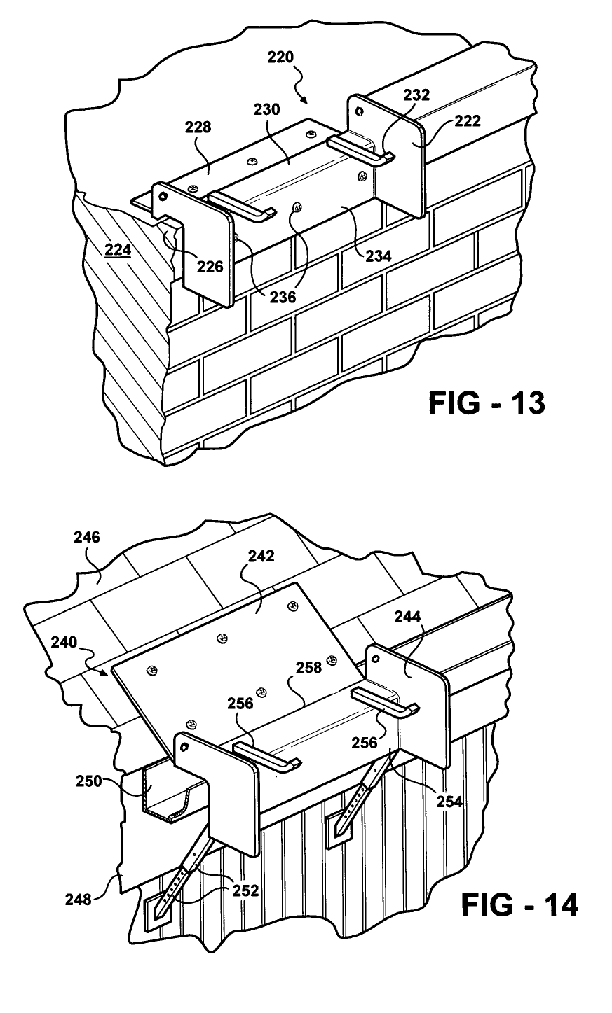

FIG. 12 illustrates a ladder receiver in combination with a roof curb. This embodiment is generally denoted by the numeral 200, and includes an end plate 202 and the ladder rung catchers 204. As this is a side view of the embodiment, it must be noted that there are preferably at least two end plates and at least two ladder rung catchers, 202 and 204, respectively. A roof curb 206 is fastened and flashed to roof 208. The roof curb which is described herein may be any type of roof curb, but generally includes a sheet metal box utilized for building functions. The roof curb may optionally include a roofing membrane 218 and the top plate 220 of the ladder securement device. An optional roof seal 212 may be utilized between top plate 220 and the roof curb and/or a membrane 212 on top of the roof curb. Top plate 220 may be secured to the roof curb 206 by fasteners 210. In addition, wall face fastener 216 may extend through the roof securement device 200 and through the roof flashing 214, which extends across the roof in and around the roof curb 206 and extends over the roof edge.

FIG. 13 illustrates yet another embodiment of the present invention for use on stone stop edge roofs. This ladder securement device 220 includes a raised portion 230 to accommodate a stone stop edge roof lip 226. A top plate 228 of the ladder securement device provides a raised portion 230 to allow clearance for the stop edge stone roof lip 226. If included, ladder rung catchers 232 will be securely fastened to raised portion 230 to catch the rungs of a ladder. Face plate 234 may be fastened to the front of a building through fastener holes 236. It is further envisioned that the ladder rung catchers may or may not be utilized, and the end plates 222 may be made of a wire, or steel rod, or any suitable material for preventing ladders from sliding side to side.

FIG. 14 illustrates an embodiment useful in an application where there is a pitched roof with a gutter on the edge, as is common in residential roofing applications. A ladder securement device suitable for such an application is generally denoted by the numeral 240, and may include either a permanently bent or a hinged top plate 242. End plates 244 and ladder rung catchers 256, common to many of the embodiments of the present invention, may also be included. Ladder securement device 240 is attached to the roof 246 via the top plate 242 on top of building 248 and will provide a more secure place to reset the top of a ladder. If this embodiment is made to be adjustable, it would be preferable to include a hinge 258 which would hingably attach top plate 242 to the ladder securement device in an adjustable angular configuration to accommodate any pitch of a roof. Normally, in residential applications, a gutter 250 is placed along the drip edge of the roof 246, to direct the water away from the foundation of the home. In order to accommodate this gutter, the ladder securement device 240 may also include a wall mount 252 extending from the face plate 254 to attach to building 248. In order to keep with the adjustability of this particular embodiment, it is preferred that wall mount 252 be an adjustable length, i.e. telescoping, or L-bracket adjustability, or any other well-known method for adjusting the length of a leg extending from the face plate 254 to an anchor plate or to the building 248.

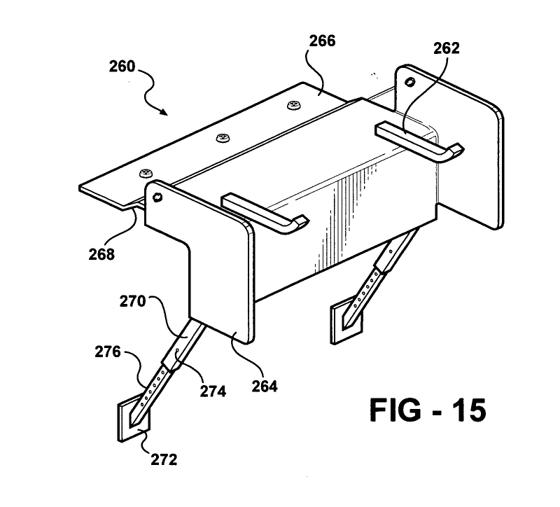

FIG. 15 illustrates yet one more embodiment of a ladder securement device generally denoted by numeral 260, and illustrates an embodiment which is generally adaptable and adjustable for a flat roof which is made to allow for passage of a gutter off of a flat roof. Ladder securement device 260 includes ladder rung catchers 262, optionally, as well as end plates 264. These items may be collectively utilized or singly utilized in this embodiment, and both are attached to a plate 266 which is to be secured onto the roof of a building (not shown). For this flat roof embodiment, it is advantageous to allow a raised portion to give a stone stop edge clearance 268. A wall mount leg 270 is attached to an anchor plate 272 by an adjustable length leg 274. Preferably, a telescoping leg 276 is utilized to adjust the length of the leg for attachment to the building. Top plate 266 may include fastening holes drilled therethrough to allow the installation, whether permanent or temporary, onto a roof. The adjustable wall mount leg 270 may be utilized as an adjustable feature, or may be of a single length if the dimension is known beforehand. The adjustable leg may include pins and screws for securement after adjusting, or any other known means for making an adjustable length of a leg. Ladder securement device 260 will therefore attach to the top of the building via top plate 266 and will attach to the side of the building via wall mount leg 270. This will allow a gutter to extend underneath the ladder securement device 260 without damaging the gutter.

After seeing these many embodiments, it may become clear to one of ordinary skill in the art for modifications and alterations in a minor way to adjust to a particular roof configuration application. The present invention includes a scope which will cover all of those modifications and deviations. The top plate as illustrated in many of the embodiments may be a single piece of metal, which may include the use of aluminum, anodized steel, or any other weather resistant suitable material known in the art. Furthermore, these top plates may not be top plates at all, but may be rather wire configurations similar to those shown in FIG. 4.

The inventor would also like to note that the face plate as commonly shown in many of the embodiments may also include a cut out portion to accommodate the shoe or boot of the person climbing the ladder. Although not shown in many of the embodiments, it is clearly envisioned by the present inventor that such a cut out portion may be more advantageous in certain applications.

In all of the embodiments above, of the two basic elements, including the building attachment and the various ladder securement features, including the end plates and the ladder rung catchers, it must be noted that one or the other of the ladder securement features may be utilized either singly or in combination. For instance, the use of an end plate may be accomplished by many different support mechanisms as shown in FIGS. 1 through 15. Further, the ladder rung catcher, although very helpful in certain applications, is not necessary in some of the applications. Therefore, the ladder rung catchers may be optional in certain embodiments.

As one can imagine, there will be many other embodiments of the present invention which will also meet the desires and advantages. However, the basic form of the present invention includes a means for helping to prevent ladders from sliding sideways, and preferably includes a means for preventing a ladder from falling backward and to help prevent the ladder base from slipping on a slippery ground surface so that the ladder slips out away from the building, causing the user to fall. As the safety of workers become more and more important as time goes on, the present invention will help give reassurances to those men and women climbing onto roofs to provide maintenance, and/or other functions.

In summary, numerous benefits have been described which result from employing any or all of the concepts and the features of the various specific embodiments of the present invention, or those that are within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings with regards to the specific embodiments. The embodiment was chosen and described in order to best illustrate the principles of the invention and its practical applications to thereby enable one of ordinary skill in the art to best utilize the invention in various embodiments and with various modifications as are suited to the particular use contemplated. It is intended that the scope of the invention be defined by the claims which are appended hereto.

1. A ladder securement device for attachment to a building and for helping to secure a ladder leaning up against that building, comprising:
a roof attachment for attaching to a roof edge of a building;
a securement device permanently fastened to the roof attachment, said securement device being adapted to receive a ladder so that it is less likely that a ladder leaning against the building will come away from the building, thereby creating an unsafe situation of the ladder; and
at least one ladder catcher permanently affixed to the securement device for receiving at least a portion of the ladder.

2. The ladder securement device of claim 1, wherein the attachment includes a roof attachment selected from the group consisting of metal plates, formed metal wire, formed plastic handles, cutout metal plates, and combinations thereof.

3. The ladder securement device of claim 1, wherein the securement device includes at least one end plate for helping to prevent a ladder leaning against the building from shifting side to side, causing a less safe situation than having a secure stationary ladder.

4. The ladder securement device of claim 1, wherein the securement device includes at least one ladder rung catcher for helping to prevent a ladder leaning thereagainst from coming away from the building, causing a less safe situation than having a secure stationary ladder.

5. The ladder securement device of claim 1, wherein the securement device includes end plates and ladder rung catchers for helping to prevent a ladder leaning thereagainst from coming away from the building, causing a less safe situation than having a secure stationary ladder.
